(19) United States
(12) Patent Application Publication
(10) Pub. No.: US 2017/0252690 A1
(43) Pub. Date: Sep. 7, 2017

(54) PARTICULATE FILTER FOR AN EXHAUST SYSTEM AND METHOD OF MAKING SUCH A PARTICULATE FILTER

(71) Applicant: AUDI AG, Ingolstadt (DE)

(72) Inventors: Peter Maischak, Ingolstadt (DE); Felix Knackstedt, Ingolstadt (DE)

(73) Assignee: AUDI AG, Ingolstadt (DE)

(21) Appl. No.: 15/440,732

(22) Filed: Feb. 23, 2017

(30) Foreign Application Priority Data
Mar. 2, 2016 (DE) 10 2016 002 517.4

(51) Int. Cl. B01D 46/24; F01N 3/021; B01D 46/00

(52) U.S. Cl. CPC B01D 46/2403; B01D 46/0001; F01N 3/021; B01D 2279/30

(57) ABSTRACT

A particulate filter for an exhaust system includes a housing having an exhaust inlet and an exhaust outlet. Arranged in the housing is a porous filter body which has a closed casing and plural flow passages extending in parallel relationship. The filter body defines a longitudinal center axis and has a conical configuration in relation to the longitudinal center axis, with each of the flow passages defining a longitudinal center axis which extends in parallel relationship to the longitudinal center axis of the filter body.

### CROSS-REFERENCES TO RELATED APPLICATIONS

This application claims the priority of German Patent Application, Serial No. 10 2016 002 517.4, filed Mar. 2, 2016, pursuant to 35 U.S.C. 119(a)-(d), the disclosure of which is incorporated herein by reference in its entirety as if fully set forth herein.

### BACKGROUND OF THE INVENTION

The present invention relates to a particulate filter for an exhaust system and method of making such a particulate filter.

The following discussion of related art is provided to assist the reader in understanding the advantages of the invention, and is not to be construed as an admission that this related art is prior art to this invention.

An exhaust system may be operably connected to any device that produces exhaust, for example an internal combustion engine or the like, so as to release exhaust from the device to the outside environment. The exhaust system includes at least an emission-control device, such as a particulate filter, to remove particles, e.g. soot particles, from the exhaust flowing through the exhaust system. Of course, the exhaust system may additionally include at least one further emission-control device, such as a catalytic converter or a further particulate filter.

It would be desirable and advantageous to obviate other prior art shortcomings.

### SUMMARY OF THE INVENTION

According to one aspect of the present invention, a particulate filter for an exhaust system includes a housing having an exhaust inlet and an exhaust outlet, and a porous filter body arranged in the housing and including a closed casing and plural flow passages extending in parallel relationship, the filter body defining a longitudinal center axis and having a conical configuration in relation to the longitudinal center axis, with each of the flow passages defining a longitudinal center axis which extends in parallel relationship to the longitudinal center axis of the filter body.

A particulate filter according to the present invention is compact so that available installation space can be best utilized and yet efficiency is superior. The housing advantageously encloses the filter body in its entirety, in particular in circumferential direction with respect to a longitudinal center axis of the filter body. Suitably, the exhaust inlet and exhaust outlet are ports that can be connected to exhaust pipes, respectively.

The filter body is made of porous material, e.g. ceramics. Examples of ceramics include silicon carbide (SiC), cordierite, or like material. The filter body may be made by extrusion from the afore-mentioned material. During extrusion, also the flow passages that extend parallel in flow direction can be formed in the filter body, with at least some of the flow passages providing a flow communication between the exhaust inlet and the exhaust outlet. Provision may hereby be made to force the exhaust to flow through different flow passages, e.g. by closing at least one of the flow passages. When entering a closed one of the flow passages, exhaust is compelled to migrate through the pores of the filter body into another one of the flow passages before being able to exit through the exhaust outlet.

The filter body has a closed casing which is fluidtight, i.e. no escape of exhaust is possible. The casing may be applied during extrusion, for example, or after extrusion by an appropriate processing step. The casing may be realized by coating the porous filter body for example.

The filter body defines a longitudinal center axis which extends from an inlet side of the filter body to an outlet side of the filter body. The filter body is configured conically with respect to this longitudinal center axis, i.e. the filter body has a frustoconical shape. The casing of the filter body has two end faces which may be designated as base area and top area, respectively, with one of the end faces situated on the inlet side and the other end face situated on the outlet side. Both end faces advantageously extend parallel to one another and have different surface areas as a result of the conical shape. The end faces may be arranged in centered relation to the longitudinal center axis.

Still, while the filter body has a conical shape, the flow passages extend in parallel relation to the longitudinal center axis of the filter body, i.e. the flow passages define each a longitudinal center axis which extends parallel to the longitudinal center axis of the filter body. As a result of the conical shape of the filter body, not all flow passages of the filter body extend therefore all the way in axial direction from the inlet side to the outlet side. It is thus possible that at least one or several flow passages is/are cut off, in part or entirely, by the casing so that exhaust flowing in this/these flow passage(s) is unable to flow through the entire filter body. Rather, exhaust is forced by the cutoff of the flow passage as caused by the casing to migrate through the filter body in the direction of an adjacent flow passage. As a result, a particulate filter according to the present invention exhibits a superior cleaning performance. The conical shape of the filter body enables in addition a very compact and flexible installation.

According to another advantageous feature of the present invention, the filter body has an inlet side on a side of the exhaust inlet and an outlet side on a side of the exhaust outlet, wherein a plurality of plugs can be provided to selectively close some of the flow passages on the inlet side or outlet side. Each plug is sized long enough to extend at least over a fraction of the filter body in axial direction. For example, each plug can have an axial length dimension which is at most 5%, or at most 2.5%, or at most 1%, or at most 0.5%, or at most 0.1% of the length dimension of the filter body in axial direction. Each plug is thus configured long enough to ensure a complete closing of the associated flow passage. The plug can be inserted in the flow passage on the inlet side or outlet side of the filter body. Accordingly, exhaust is either prevented from flowing via the exhaust inlet into the flow passage or from flowing out the flow passage in direction of the exhaust outlet. Any exhaust in this flow passage can thus again only migrate through the porous filter body in the direction of a flow passage that is long enough to reach the outlet side and is not sealed off by a plug. Advantageously, several of the flow passages on both the inlet side and the outlet side are closed by respective plugs.

According to another advantageous feature of the present invention, the filter body can have on the inlet side a cross section which is greater than a cross section on the outlet side so that only some of the flow passages have a length sufficient to extend from the inlet side to the outlet side. As described above, the conical shape of the filter body results in a configuration of flow passages that are cutoff by the casing and thus do not completely extend through the filter body. For example, the filter body can have on the inlet side the base area and on the outlet side the top area of the truncated cone, with the base area spanning a greater surface area than the top area. Thus, some flow passages begin on the inlet side but do not reach the outlet side because they are either cutoff by the casing or closed by plugs. Only some other flow passages reach the outlet side, in particular from the inlet side, and advantageously have a same cross section.

According to another advantageous feature of the present invention, the flow passages of a first plurality of the flow passages can be closed by plugs on the inlet side, when the outlet side of the flow passages of the first plurality of flow passages remains open. Those flow passages are thus advantageously closed which completely extend through the filter body in axial direction, i.e. these flow passages extend from the inlet side to the outlet side, even though part of the flow cross section of some flow passages is restricted in the direction of the outlet side because of the presence of the casing. Therefore, at least some of the flow passages on the inlet side are closed that are dimensioned to reach the outlet side, i.e. extend through the entire filter body in axial direction, and have not been closed on the outlet side by associated plugs. Although it is currently preferred to close all those flow passages for which the afore-stated conditions apply, it will be understood that, of course, only some of those flow passages may be closed on the inlet side. All flow passages which extend from the inlet side through the entire filter body to the outlet side are thus either closed on the inlet side or the outlet side, for example by plugs as described above.

According to another advantageous feature of the present invention, a restraining element resting against the casing can be provided for support of the filter body upon a conical inner wall of the housing. Thus, both the filter body and the inner wall of the housing have a conical configuration, i.e. the entire housing, especially an outer side of the housing, can be of conical shape. Advantageously, the casing extends parallel to the inner wall, as viewed in a longitudinal section relative to the longitudinal center axis of the filter body. Thus, the filter body has a same distance at the same circumferential position to the inner wall of the housing at all times, when the filter body is arranged axially in straight arrangement in the housing.

The restraining element is arranged between the filter body, i.e. casing thereof, and the inner wall of the housing and advantageously embraces the filter body in circumferential direction. Advantageously, the restraining element is fluidtight and rests snugly on both the casing and the inner wall so that exhaust is prevented from flowing between the casing and the inner wall from the exhaust inlet to the exhaust outlet and thus past the filter body.

According to another advantageous feature of the present invention, the restraining element can be elastic. In this way, the filter body is able to shift in the housing at least in one direction. For example, the restraining element permits a shift of the filter body in the housing in axial direction and/or radial direction in relation to the longitudinal center axis of the filter body. As the filter body shifts, the restraining element thus undergoes an elastic deformation, thereby applying on the filter body a restoring force by which the filter body is urged to seek its initial position.

According to another advantageous feature of the present invention, the filter body can be arranged in the housing with clearance in an axial direction. The filter body is advantageously supported in the housing in axial direction solely by the restraining element. As the restraining element is, however, elastic, a shift of the filter body is thus possible, as the restraining element deforms, as described above. For this purpose, the filter body is supported in at least one position, in particular in axial direction, exclusively by the restraining element upon the housing.

According to another advantageous feature of the present invention, an end stop can be provided to limit the clearance of the filter body in the housing. The presence of the end stop prevents excessive shifting of the filter body, especially in axial direction. Advantageously, the end stop is situated on the inlet side of the filter body. However, since both the filter body and the inner wall of the housing are conical in shape, any shift by the filter body in the direction of the outlet side or direction of the exhaust outlet is restricted anyway, because the shift causes a compression of the restraining element that is not unlimited. In addition or as an alternative, the end stop or a further end stop may be placed, of course, on the outlet side of the filter body.

According to another advantageous feature of the present invention, the flow passages of a first plurality of the flow passages (hereinafter referred to as “first flow passages”) can have each a cross section which differs from a cross section of the flow passages of a second plurality of the flow passages (hereinafter referred to as “second flow passages”). The first and second flow passages thus have cross sections that differ from one another. Advantageously, the first flow passages can hereby have a same cross section and the second flow passages can have a same cross section. The term “cross section” is hereby to be understood as referring to the cross section of a flow passage on the inlet side of the filter body, because the cross section in some of the flow passages decreases as a result of the conical shape of the filter body and the casing in the direction of the outlet side. Thus, cross section of each of the flow passages refers to the greatest cross section encountered in axial direction.

Provision may be made for the first flow passages to have a smaller cross section than the second flow passages. For example, the cross section of the first flow passages in relation to the cross section of the second flow passages is at most 90%, or at most 80%, or at most 75%, or at most 70%, or at most 60%, or at most 50%.

Provision may also be made for the first flow passages to extend to the outlet side and for the second flow passages to end between the inlet side and the outlet side. For example, all those flow passages that completely extend through the filter body in axial direction, i.e. extend from the inlet side to the outlet side, can represent the first flow passages. Those flow passages that are cutoff by the casing in axial direction and thus extend through the filter body from the inlet side only to a limited extent towards the outlet side can represent the second flow passages.

In such a configuration of the particulate filter, exhaust flows advantageously through the first flow passages, when smaller exhaust mass flow rates are involved so that pressure loss is smaller across the filter body compared to the second flow passages. Thus, when smaller exhaust mass flow rates are involved, pressure loss of the particulate filter is overall minor while the filtering effect is still very good. Conversely, when greater exhaust mass flow rates are involved, exhaust can also flow through the second flow passages. As the second flow passages are limited in their length dimension and do not reach the outlet side, exhaust flowing in the second flow passages is forced to migrate through the porous filter body.

There may be the case that exhaust has to migrate from a flow passage to another flow passage which, in turn, does also not extend entirely through the filter body or may be closed on the outlet side by a plug. In this scenario, exhaust again is compelled to flow through the porous filter body to a still further flow passage, so that the filtering effect is enhanced, when greater exhaust mass flow rates are involved. Overall, a particulate filter according to the present invention thus has a minor pressure loss when smaller exhaust mass flow rates are involved, and an enhanced filtering effect when greater exhaust mass flow rates are involved.

According to another aspect of the present invention, a method of making a particulate filter for an exhaust system includes forming a porous filter body of conical configuration in relation to a longitudinal center axis thereof with a closed casing and plural flow passages extending in parallel relationship, such that each of the flow passages defines a longitudinal center axis which extends in parallel relationship to the longitudinal center axis of the filter body, forming a housing with an exhaust inlet and an exhaust outlet, and placing the filter body in the housing.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section of a particulate filter according to the present invention for use in an exhaust system; and

FIG. 2 is a cross section of the particulate filter.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

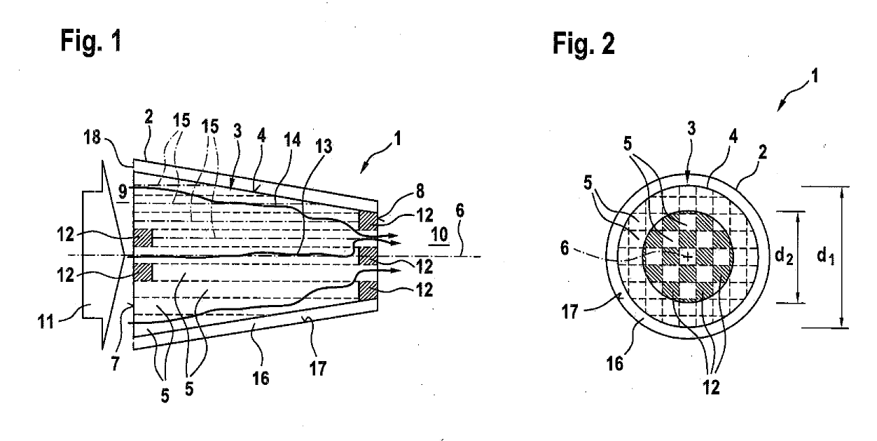

Turning now to the drawing, and in particular to FIG. 1, there is shown a longitudinal section of a particulate filter according to the present invention, generally designated by reference numeral 1, for use in an exhaust system. The particulate filter 1 includes a housing 2, shown here only in part, and a filter body 3 which is arranged in the housing 2 and is made of porous material. The filter body 3 has a closed casing 4 which may be in the form of a coating and/or realized by appropriately treating the filter body 3. A number of flow passages 5, extending in parallel relation in flow direction of exhaust, are formed in the filter body 3. Only few of the flow passages 5 are shown here by way of example for sake of simplicity. As is readily apparent, the filter body 3 has a conical configuration with respect to its longitudinal center axis 6 and defines two end faces 7, 8 which are connected to one another by the casing 4. FIG. 1 further shows that the end face 7 is sized greater in a radial direction with respect to its longitudinal center axis 6 than the end face 8, so that the surface area of the end face 7 is greater than the surface area of the end face 8.

The end face 7 of the filter body 3 is situated at an inlet side 9 of the filter body 3 and the end face 8 is situated at an outlet side 10 of the filter body 3. Exhaust flows through the particulate filter 1 and the filter body 3 thereof in a direction of arrow 11. Several of the flow passages 5 on both the inlet side 9 and the outlet side 10 are each snugly closed or sealed by a plug 12. In terms of the inlet side 9, this means that exhaust is unable to enter the respective flow passage 5. When the respective flow passage 5 is closed on the outlet side 10, exhaust is unable to exit the filter body 3 from this flow passage 5. Currently preferred is a closure of all those flow passages 5 either on the inlet side 9 or outlet side 10 by a plug 12 that extend through the entire filter body 3. Arrow 13 indicates hereby, by way of example, a flow of exhaust through the filter body 3. As a result, exhaust is able to enter the open flow passages 5 on the inlet side 9. On the outlet side 10, these flow passages 5 are, however, closed to prevent exhaust from exiting these flow passages 5. As a result, exhaust is forced to migrate through the porous filter body 3 into a flow passage 5 that is open on the outlet side 10. As exhaust migrates through the filter body 3, it is cleaned and, at least substantially freed from unwanted particles before being released into the outside environment.

As described above, the inlet side 9 of the filter body 3 spans a greater surface area than the outlet side 10. Thus, there are flow passages 5 which extend from the inlet side 9 of the filter body 3 but do not fully extend through the filter body 3 in an axial direction as they are cut off by the casing 4. Advantageously, these types of flow passages 5 remain open at all times on the inlet side 9, so that exhaust entering these flow passages 5 are compelled to at least once, suitably however several times, migrate through the porous filter body 3 until reaching a flow passage 5 that is open on the outlet side 10, as indicated by arrow 14. This results in a superior filtering effect.

In general, the flow passages 5 extend in a straight line through the filter body 3 and define each a longitudinal center axis 15 which extends in parallel relation to the longitudinal center axis 6 of the filter body 3. Some of the flow passages 5 have hereby a shorter axial dimension than others as a result of the conical configuration of the filter body 3. The longitudinal center axes 15 of the flow passages 5 thus extend perpendicular to the inlet side 9 and/or outlet side 10.

The filter body 3 is supported in the housing 2 by a restraining element 16 which bears upon the casing 4 and upon a conically inner wall 17 of the housing 2. As a result, the filter body 3 is supported by the restraining element 16 upon the inner wall 17 of the housing 2. The restraining element 16 is elastic and may be embodied in the form of a fiber mat. The restraining element 16 is advantageously fluidtight and rests snugly upon the casing 4 and the inner wall 17 so that exhaust is prevented from flowing between the casing 4 and the inner wall 17 past the filter body 3.

The filter body 3 is arranged with axial clearance in the housing 2. The clearance is limited at least on one side of the filter body 3, in particular on the inlet side 9, by an end stop 18 in the form of a support ring or supporting grid for example. Such a configuration of the particulate filter 1 has the advantage that an increasingly greater force is applied by exhaust upon the filter body 3, as the exhaust mass flow rate increases, in order to urge the filter body 3 in a direction of the exhaust flow, i.e. in flow direction. The force urges the filter body 3 onto the restraining element 16 and away from the end stop. 18. Thus, the filter body 13 is increasingly moved away from the end stop 18 with increasing exhaust mass flow rate as the force applied by exhaust on the filter body 3 in turn increases.

At the same time, as the force applied by exhaust increases, the restoring force 16 applied by the restraining element 16 increases on the filter body 3 so that the filter body 3 is urged to seek its initial position. This correlation has also an effect on the sealing action between the restraining element 16 on one hand, and the casing 4 and the inner wall 17, on the other hand. Accordingly, the sealing action increases as the exhaust mass flow rate increases. In addition, the slanted casing 4 as a result of the conical shape of the filter body 3, results in a smooth and gentle conduction of exhaust so that pressure loss of the particulate filter 1 is significantly reduced, when compared to conventional particulate filters.

FIG. 2 is a cross sectional view of the particulate filter 1. The inlet side 9 and the outlet side 10 of the filter body 3 are depicted and it is readily apparent that the end faces 7 and 8 are each round. The inlet side 9 is defined by a diameter d₁ and the outlet side 10 is defined by a diameter d₂. When smaller exhaust mass flow rates are involved, exhaust enters on the inlet side 9 those flow passages 5 which extend entirely through the filter body 3 in the axial direction. The reason being that these flow passages 5 have a lowest flow resistance. With increasing exhaust mass flow rate, however, increasingly more exhaust enters also those flow passages 5 which extend through the filter body 3 in the axial direction only in part, as described above.

Provision may be made to divide the flow passages 3 in a first type of flow passages and a second type of flow passages, with the first flow passages having a same cross section and the second flow passages having a same cross section, with the cross section of the first flow passages being different, advantageously smaller, than the cross section of the second flow passages. The first flow passages involve flow passages 5 that extend completely through the filter body 3 in the axial direction, whereas the second flow passages involve flow passages 5 that extend only in part through the filter body 3 in the axial direction.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A particulate filter for an exhaust system, comprising:
a housing having an exhaust inlet and an exhaust outlet; and
a porous filter body arranged in the housing and including a closed casing and plural flow passages extending in parallel relationship, said filter body defining a longitudinal center axis and having a conical configuration in relation to the longitudinal center axis, with each of the flow passages defining a longitudinal center axis which extends in parallel relationship to the longitudinal center axis of the filter body.

2. The particulate filter of claim 1, wherein the filter body has an inlet side on a side of the exhaust inlet and an outlet side on a side of the exhaust outlet, and further comprising a plurality of plugs to selectively close some of the flow passages on the inlet side or outlet side.

3. The particulate filter of claim 1, wherein the filter body has an inlet side on a side of the exhaust inlet and an outlet side on a side of the exhaust outlet, with the filter body having on the inlet side a cross section which is greater than a cross section on the outlet side so that only some of the flow passages have a length sufficient to extend from the inlet side to the outlet side.

4. The particulate filter of claim 2, wherein the flow passages of a first plurality of the flow passages are closed by plugs on the inlet side, when the outlet side of the flow passages of the first plurality of flow passages remains open.

5. The particulate filter of claim 1, further comprising a restraining element resting against the casing for support of the filter body upon a conical inner wall of the housing.

6. The particulate filter of claim 5, wherein the restraining element is elastic.

7. The particulate filter of claim 1, wherein the filter body is arranged in the housing with clearance in an axial direction.

8. The particulate filter of claim 7, further comprising an end stop to limit the clearance of the filter body in the housing.

9. The particulate filter of claim 1, wherein the flow passages of a first plurality of the flow passages have each a cross section which differs from a cross section of the flow passages of a second plurality of the flow passages.

10. The particulate filter of claim 1, constructed for installation in an exhaust system of a motor vehicle.

11. A method of making a particulate filter for an exhaust system, comprising:
forming a porous filter body of conical configuration in relation to a longitudinal center axis thereof with a closed casing and plural flow passages extending in parallel relationship, such that each of the flow passages defines a longitudinal center axis which extends in parallel relationship to the longitudinal center axis of the filter body;
forming a housing with an exhaust inlet side and an exhaust outlet side; and
placing the filter body in the housing.

12. The method of claim 11, further comprising at least partially closing a selected number of flow passages on the inlet side or outlet side with plugs.

13. The method of claim 12, wherein the filter body has on the inlet side a cross section which is greater than a cross section on the outlet side so that only some of the flow passages have a length sufficient to extend from the inlet side to the outlet side.

14. The method of claim 12, further comprising closing only those flow passages by plugs on the inlet side, when the outlet side of those flow passages remains open.

15. The method of claim 11, further comprising supporting the filter body upon a conical inner wall of the housing by a restraining element resting against the casing.

16. The method of claim 15, wherein the restraining element is elastic.

17. The method of claim 11, further comprising arranging the filter body in the housing with clearance in an axial direction.

18. The method of claim 17, further comprising limiting the clearance of the filter body in the housing by an end stop.

19. The method of claim 11, wherein the flow passages of a first plurality of the flow passages have each a cross section which differs from a cross section of the flow passages of a second plurality of the flow passages.
